(19) United States
(12) Patent Application Publication
(10) Pub. No.: US 2008/0084354 A1
(43) Pub. Date: Apr. 10, 2008

(54) Antenna device and method of manufacturing the same

(76) Inventor: Shinzo Komoto, Okayama (JP)

Correspondence Address: MCDERMOTT WILL & EMERY LLP, 600 13TH STREET, NW, WASHINGTON, DC, 20005-3096, US

(21) Appl. No.: 11/882,169

(22) Filed: Jul. 31, 2007

(30) Foreign Application Priority Data
Oct. 10, 2006 (JP) 2006-276223

(51) Int. Cl. H01Q 1/38; H01Q 9/04

(52) U.S. Cl. 343/700 MS; 29/600

(57) ABSTRACT

An antenna device includes an insulating base and an antenna element made of a metal plate fixed onto the base. The base has a surface having a recess therein having a bottom. A projection projects from the bottom of the recess. The antenna element has a hole in which the projection is inserted, and is fixed onto the surface of the base with the projection by swage locking. The antenna element includes a step portion provided on the bottom of the recess and a peripheral portion coupled to the step portion and provided on the surface of the base. The step portion has the hole provided therein. The projection has a height not larger than a height of the first peripheral portion of the antenna element. The antenna device has preferable antenna characteristics even while being accommodated in a small installation space.

### FIELD OF THE INVENTION

The present invention relates to an antenna device for use in a small communication apparatus, such as a mobile communication apparatus, and to a method of manufacturing the antenna device.

### BACKGROUND OF THE INVENTION

Small, light mobile communication apparatuses, such as mobile telephones, have been widely marketed. The communication apparatuses are commonly equipped with built-in antennas in their cases. Being built in, the antennas are hardly injured even when the communication apparatuses drop down accidentally.

FIG. 5 is an external perspective view of a conventional antenna device 501 disclose in Japanese Patent Laid-Open Publication No. 2005-5954. FIGS. 6 and 7 illustrate a side view and an exploded perspective view of the antenna device 501, respectively. The antenna device 501 includes a base 1 made of synthetic resin base 1 and an antenna element 5 made of a metal plate. The base 1 has substantially a rectangular parallelepiped shape. The antenna element 5 is fixed onto the base 1.

The antenna element 5 is situated on both upper surface 1A and rear side surface 1B of the base 1. As shown in FIG. 7, swage-locking projections 2 having circular column shapes are provided on the surfaces 1A and 1B.

The antenna element 5 has a shape corresponding to a frequency range to be transmitted and received, and has holes 7 therein into which the swage-locking projections 2 are inserted, respectively. Upon the antenna element 5 being mounted onto the base 1, holes 7 engage with the swage-locking projections 2, respectively. Tips of the swage-locking projections 2 are crushed to provide heads 2A having diameters larger than those of the projections 2, thereby causing heads 2A to secure the antenna element 5 onto the base 1.

The conventional antenna device 501 is accommodated in a case of a communication apparatus. The surface 5A of the antenna element 5 situated on the rear side surface 1B of the base 1 has a flat portion. A spring strip connected to a radio communication circuit of the communication apparatus elastically contacts the flat portion of the surface 5A of the antenna element 5.

An operation of the conventional antenna device 501 will be described below. When transmitting radio waves, a signal supplied from the radio communication circuit of the communication apparatus is transferred via the spring strip to the antenna element 5, and then, emitted to air as the radio waves. When receiving radio waves, the radio waves are received by the antenna element 5, and then, a signal of the radio wave is transferred via the spring strip to the radio communication circuit.

Thin mobile telephones have been recently used as the mobile communication apparatuses. The conventional antenna device 501 accommodated in such a thin mobile telephone is hence desired to be thin so as to be arranged in a small installation space.

As the base 1 has its size reduced, the antenna device 501 may be accommodated in such small installation space. In order to maintain predetermined antenna characteristics, the antenna element 5 is necessarily fixed onto the base 1, hence requiring the heads 2A of the swage-locking projections 2 which have predetermined heights for fixing. As the installation space for the antenna device 501 decreases, the heights of the heads 2A of projections 2 occupy a large portion of the size of the antenna device 501. The heights of heads 2A may increase, and accordingly cause the volume of the antenna device 501 functioning as an antenna to be smaller than the installation space, accordingly causing the antenna characteristics deteriorate.

### SUMMARY OF THE INVENTION

An antenna device includes an insulating base and an antenna element made of a metal plate fixed onto the base. The base has a surface having a recess therein having a bottom. A projection projects from the bottom of the recess. The antenna element has a hole in which the projection is inserted, and is fixed onto the surface of the base with the projection by swage locking. The antenna element includes a step portion provided on the bottom of the recess and a peripheral portion coupled to the step portion and provided on the surface of the base. The step portion has the hole provided therein. The projection has a height not larger than a height of the first peripheral portion of the antenna element.

The antenna device has preferable antenna characteristics even while being accommodated in a small installation space.

### BRIEF DESCRIPTION OF THE DRAWINGS

FIG. 1A is an external perspective view of an antenna device according to an exemplary embodiment of the present invention.

FIG. 1B is a perspective view of a communication apparatus having the antenna device accommodated therein according to the embodiment.

FIG. 2A is a perspective view of the antenna device shown in FIG. 1A.

FIG. 2B is a cross sectional view of the antenna device at line 2B-2B shown in FIG. 1A.

FIG. 3 is an external perspective view of another antenna device according to the embodiment.

FIG. 4 is an exploded perspective view of the antenna device shown in FIG. 3.

FIG. 5 is an external perspective view of a conventional antenna device.

FIG. 6 is a side view of the conventional antenna device.

FIG. 7 is an exploded perspective view of the conventional antenna device.

### DETAIL DESCRIPTION OF THE PREFERRED EMBODIMENT

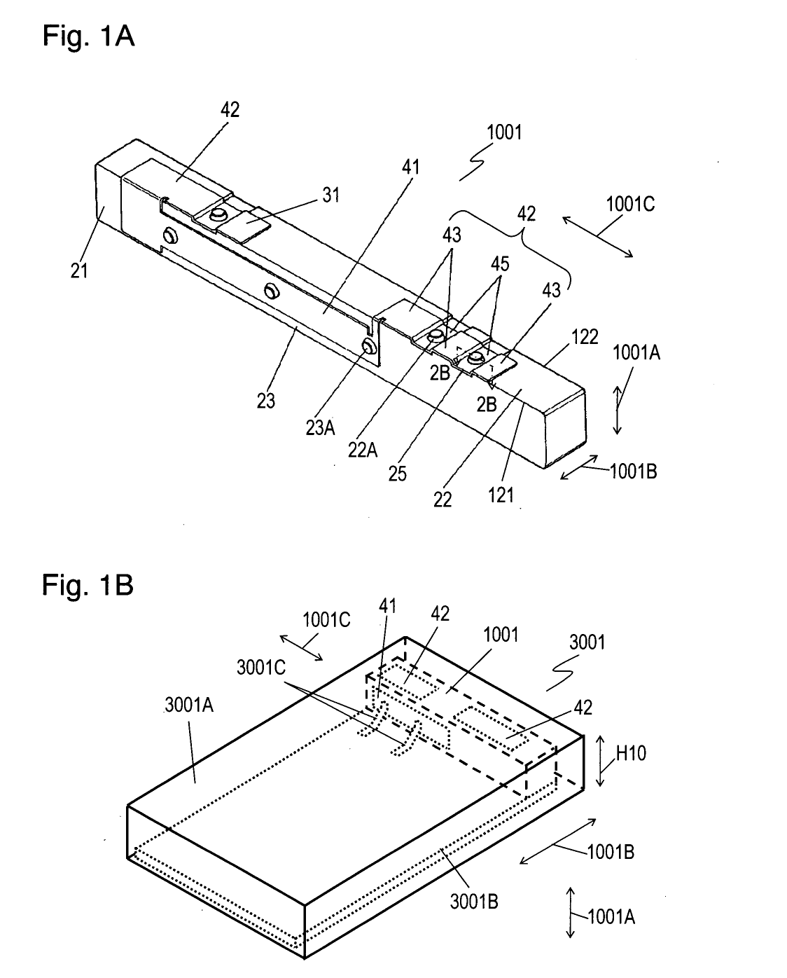

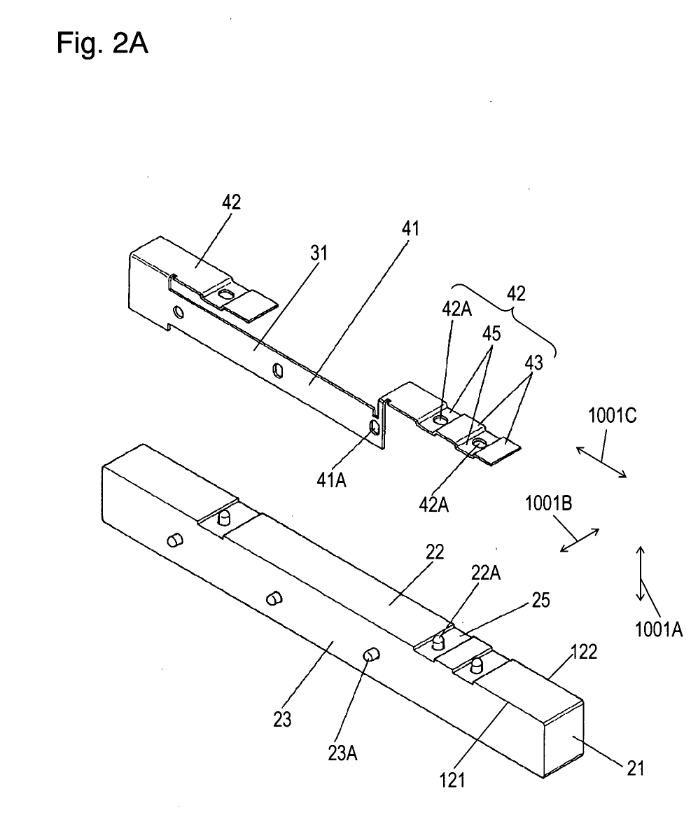

FIG. 1A is an external perspective view of an antenna device 1001 according to an exemplary embodiment of the present invention. FIG. 1B is a perspective view of a communication apparatus 3001 having the antenna device 1001 accommodated therein. FIG. 2A is an exploded perspective view of the antenna device 1001. The antenna device 1001 includes a base 21 made of insulating material, such as synthetic resin, and an antenna element 31 fixed onto the base 21. The antenna device 1001 is accommodated in a case 3001A of the communication apparatus 3001, such as a mobile telephone, and has a dimension along direction 1001A restricted by height H10 of the case 3001A.

The base 21 has substantially a rectangular parallelepiped shape. The antenna element 31 is made of a metal strip and has a shape corresponding to a frequency range to be transmitted and received. The antenna element 31 is fixed onto the base 21 by swage locking.

The base 21 has an upper surface 22 facing towards direction 1001A and a side surface 23 connected to the upper surface 22 across a first edge 121. The antenna element 31 is situated on the upper surface 22 and the side surface 23. The side surface 23 faces towards direction 1001B perpendicular to direction 1001A, that is, different from direction 1001A. The antenna element 31 has a first planer region 41 situated on the side surface 23. The side surface 23 has a flat surface. The first planer region 41 of the antenna element 31 having substantially a rectangular shape is placed on the side surface 23. Projections 23A projecting from the side surface 23 engage holes 41A provided in the first planer region 41, respectively. Tips of the projections 23A are crushed to have larger diameters, thereby joining the first planer region 41 onto the side surface 23 by swage locking. The upper surface 22 has the first edge 121 and a second edge 122 which is opposite to the first edge 121 beyond the upper surface 22 and which is connected to the upper surface 22.

The upper surface 22 of the base 21 has a recess 25 provided therein. The recess 25 opening upward has a bottom 25A. A projection 22A having a circular column shape projects from the bottom 25A of the recess 25 in the upper surface 22. The recess 25 having a predetermined width extends in parallel to short-side direction 1001B.

Two second planer regions 42 of the antenna element 31 are placed on the upper surface 22 of the base 21. The second planer regions 42 are bent perpendicularly to the first planer region 41 of the antenna element 31. The two second planer regions 42 are connected to both ends of the first planer region 41 in direction 1001D.

Each of the two second planer regions 42 has substantially a rectangular shape and includes a step portion 45 and first peripheral portions 43 which is flat and which is coupled directly to the step portion 45. The step portion 45 has a shape along the upper surface 22 of the base 21 having the recess 25 therein. The step portion 45 extends throughout the width of the upper surface 22 in short-side direction 1001D. The recess 25 provided in the upper surface 22 extends from the first edge 121 to the second edge 122. The step portion 45 has a hole 42A provided therein. The second planer region 42 of the antenna element 31 is fixed to the base 21 at the step portion 45 and the hole 42A.

FIG. 2B is a cross sectional view of the antenna device 1001 at line 2B-2B shown in FIG. 1A. The second planer regions 42 are situated on the upper surface 22 of the base 21, while the step portions 45 are situated in the recesses 25, respectively. The holes 42A are inserted in the projections 22A. The tip of each projection 22A is crushed, thus including a trunk 122A extending from the bottom 25A at the recess 25 of the base 21 and a head 222A provided at the tip of the trunk 122A. The base 21 and the projections 22A are provided unitarily. The head 222A of the projection 22 is formed by being crushed. The trunk 122A of the projection 22A is inserted in the hole 42A provided in the second plane region 42 of the antenna element 31. The head 222A has a diameter larger than that of each of the trunk 122A and the hole 42A. The tip of projection 22A is crushed, thereby fixing the second planer region 42 of the antenna element 31 onto base 21 by swage locking. The depth of the recess 25 and the shape of the step portion 45 and the recess 25 are determined such that the step portion 45 of the second planer region 42 is situated on the bottom 25A of the recess 25, and the first peripheral portions 43 of the second planer region 42 are situated on the upper surface 22. The step portion 45 and the bottom 25A of the recess 25 are flat and perpendicular to the direction in which the projection 22A projects, and hence, the tip of the projection 22A is crushed easily, accordingly facilitating the swaging operation efficiently.

The height H1 of the projection 22A (the head 222A) from the bottom 25A is not larger than a height H2 of the first peripheral portions 43 of the second planer region 42 from the bottom 25A. This structure prevents the projection 22A from projecting from the first peripheral portions 43 of the second planer region 42, hence allowing the antenna device 1001 to be accommodated in a small installation space. The height of the antenna element 31 in direction 1001A is equal to the sum of respective thicknesses of the base 21 and the first peripheral portion 43 of the antenna element 31. The height H1 of the projection 22A is preferably smaller than the height H2 of the first peripheral portion 43 under consideration to dimensional variations, hence allowing the head 222A of the projection 22A to be entirely accommodated in the recess 25. That is, the head 222A of the projection 22A does not project from the first peripheral portions 43.

As shown in FIG. 1B, the antenna device 1001 can locate the antenna element 31 at the outermost position in the installation space of the antenna device 1001 which is restricted by the internal dimensions of the case 3001A. In general, the antenna element is located in an outer position, and accordingly, the antenna element has more preferable antenna characteristics, such as sensitivity. The antenna device 1001 according to this embodiment positions the antenna element 31 at the outermost surface of the inside of the case 3001A, accordingly having preferable antenna characteristics, such as high sensitivity. In the antenna device 1001, the recesses 25 are provided in the upper surface 22 of the base 21. In an antenna device according to the embodiment, the recess may be provided in another surface of the base 21 so as to prevent the projections from projecting, providing the same effects.

As shown in FIG. 1B, the antenna device 1001 is accommodated in the case 3001A of the communication apparatus 3001. A conductive spring strip 3001C connected to a radio communication circuit 3001B elastically contacts a flat portion of the first planer region 41. When transmitting radio waves, a signal is produced by the radio communication circuit 3001B and transferred via the spring strip 3001C to the antenna element 31 to be emitted to air as the radio waves. When receiving radio waves, the radio waves are received by the antenna element 31, and then a signal of the radio waves is transferred via the spring strip 3001C to the radio communication circuit 3001B.

As described above, the antenna device 1001 according to this embodiment has a small size and has preferable antenna characteristics.

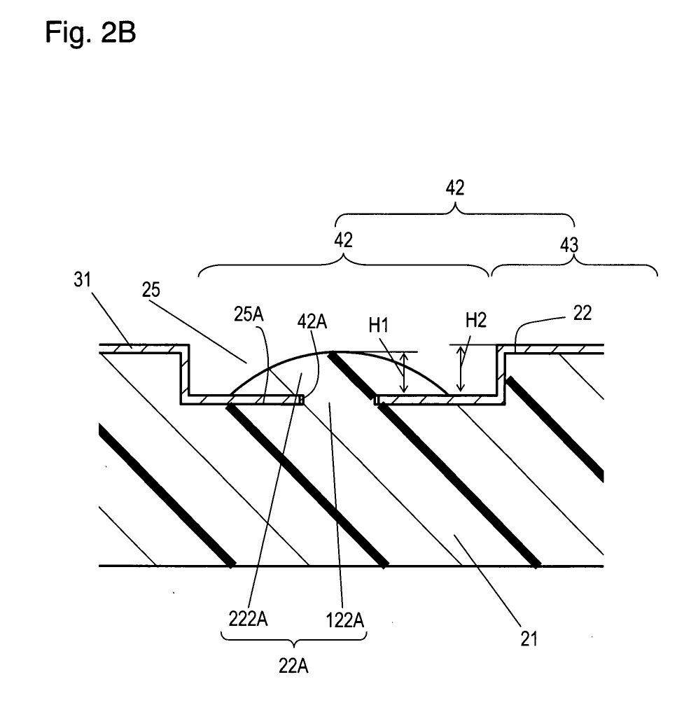

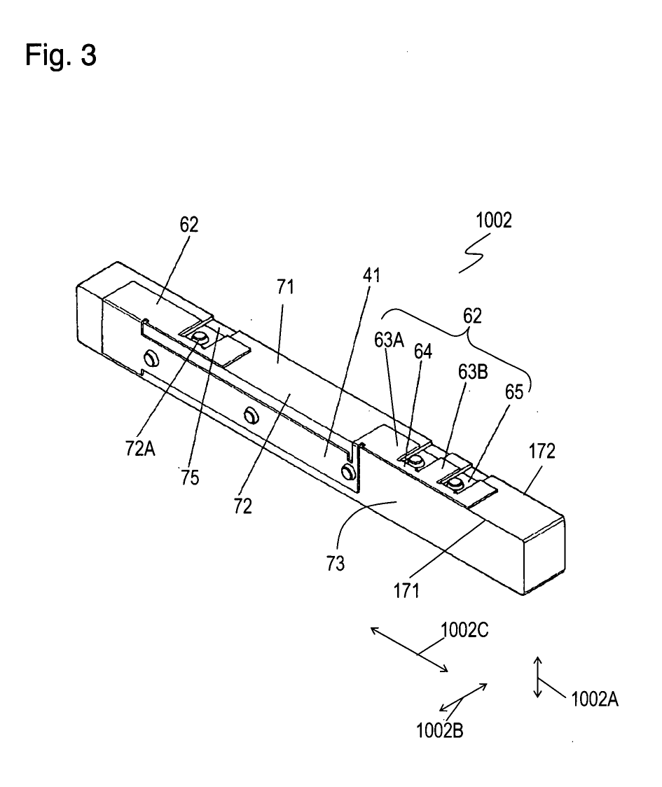

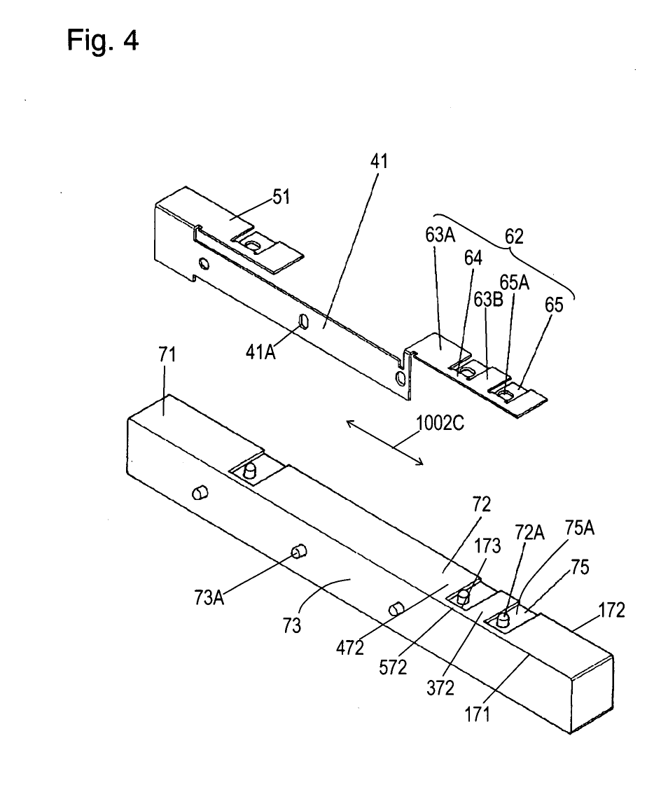

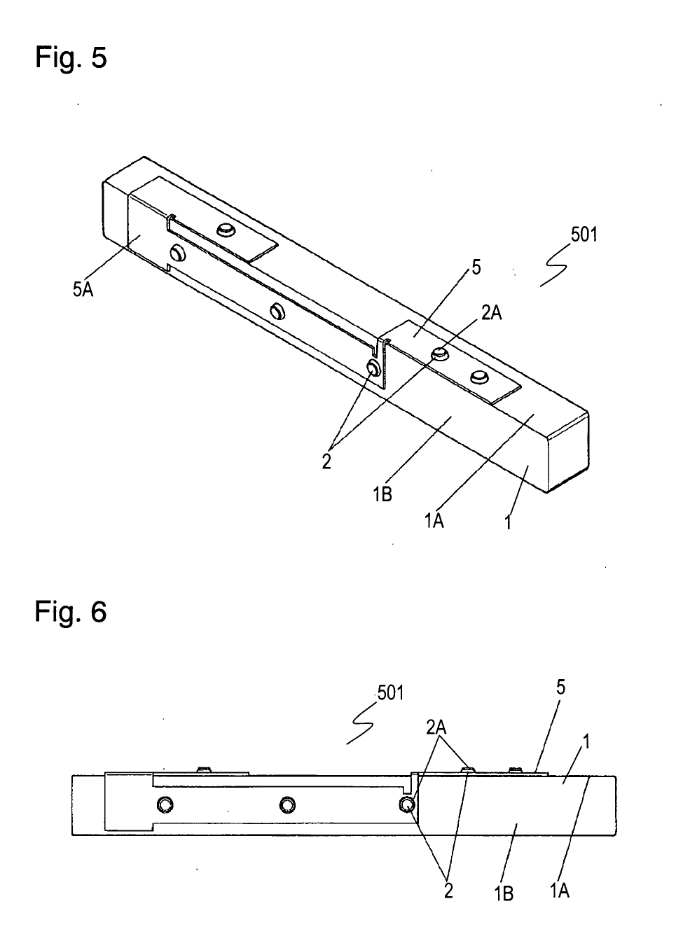

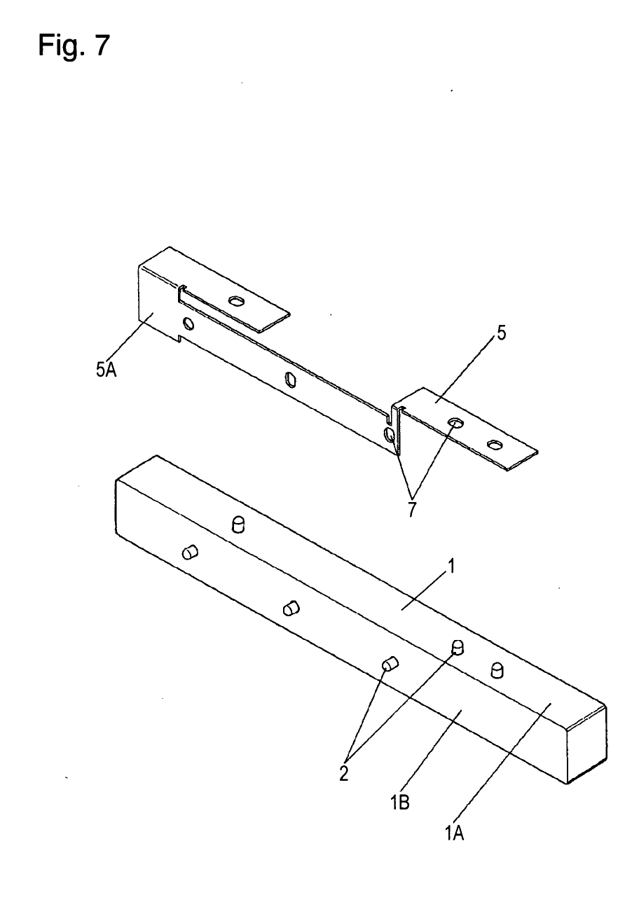

FIGS. 3 and 4 are an external perspective view and an exploded perspective view of another antenna device 1002 according to the embodiment, respectively. The antenna device 1002 includes a base 71 and an antenna element 51 fixed onto the base 71. The base 71 is made of insulating material, such as synthetic resin. The antenna device 1002 is accommodated in a case of a communication apparatus, such as a mobile telephone. The antenna device 1002 has a dimension along direction 1002A which is restricted according to the height of the case.

The base 71 has substantially a rectangular parallelepiped shape. The antenna element 51 is made of a metal plate having a shape corresponding to a frequency range to be transmitted and received. The antenna element 51 is fixed onto to the base 71 by swage locking.

The base 71 has an upper surface 72 facing towards direction 1002A in which the dimension of the device is restricted and a side surface 73 connected to the upper surface 72 across a first side 171. The antenna element 51 is situated on both the upper surface 72 and the side surface 73. The side surface 73 faces towards direction 1002B perpendicular to direction 1002A, that is different from direction 1002A. The base 71 has a longitudinal direction 1002C perpendicular to directions 1002A and 1002B. The upper surface 72 of the base 71 has the first edge 171 and a second edge 172 opposite to the first edge 171. The upper surface 72 of the base 71 has recesses 75 provided therein. Each recess 75 has a bottom 75A. The recess 75 extends from the first edge 171 to a position 173 on the upper surface 72. The position 173 is between the second edge 172 and the first edge 171. The position 173 on the upper surface 72 is closer to the first edge 171 than the second edge 172 is. The recess 75 does not reach the second edge 172, and is distanced from the second edge 172.

The antenna element 51 made of metal plate includes a first planer region 41 and second planer regions 62. The second planer regions 62 are situated on the upper surface 72 of the base 71. Each second planer region 62 includes a step portion 65 situated on the bottom 75A of the recess 75, a first peripherals portion 63A, a peripheral portion 63B, and a bridge portion 64. The peripheral portions 63A and 63B and the step portion 65 are arranged along the longitudinal direction 1002C so that the step portion 65 is located between the peripheral portions 63A and 63B. The bridge portion 64 extends along the first edge 171 and is connected between the peripheral portions 63A and 63B. The first peripheral portion 63A, the bridge portion 64, and the second peripheral portion 63B are situated on portions 472, 572, and 372 of the upper surface 72 of the base 71, respectively. The portions 372, 572, and 472 of the upper surface 72 are flush with each other. Accordingly, the peripheral portions 63A and 63B and the bridge portion 64 of the second planer region 62 are flush with each other. The step portion 65 of the second planer region 62 extends from the bridge portion 64. In other words, the step portion 65 is coupled via the bridge portion 64 to the peripheral portions 63A and 63B. A projection 72A projects upward from the bottom 75A of the recess 75 in the base 71.

The second planer regions 62 are situated on the upper surface 72 of the base 71 while each step portion 65 is placed on each bottom 75A of each recess 75. Each projection 72A is inserted in each hole 65A provided in each step portion 65. The tip of the projection 72A is crushed to have a diameter larger than that of the hole 65A, thereby fixing the step portion 65 of the antenna element 51 to the bottom 75A of the recess 75 of the base 71 be swage locking. At the time, the projections 72A like the projections 22A of the antenna device 1001 shown in FIG. 2B remain not projecting from the second planer region 62. Holes 41A are provided in the first planer region 41 of the antenna element 51. Projections 73A provided on the side surface 73 of the base 71 are inserted in holes 41A, respectively. Then, the tips of the projections 73A are crushed, thereby fixing the first planer region 41 onto the side surface 73 by swage locking.

The antenna device 1002, similarly to the antenna device 1001 shown in FIGS. 1A and 1B can located the antenna element 51 at the outermost position in a small installation space of the case of the communication apparatus. In particular, the bridge portion 64 adjacent to the step portions 65 can be located at the outermost as well as the peripheral portions 63A and 63B of the second planer region 62 of the antenna element 51. Thus, the antenna device 1002, similarly to the antenna device 1001, has a small size and preferable antenna characteristics.

The present invention is not limited to the above embodiment.

What is claimed is:

1. An antenna device comprising:
a base having an insulating property and having a surface thereof, the surface of the base having a recess provided therein, the recess of the base having a bottom, the base including a projection projecting from the bottom of the recess; and
an antenna element made of a metal plate, the antenna element having a hole provided therein, the projection being inserted in the hole of the antenna element, the antenna element being fixed onto the surface of the base with the projection by swage locking, wherein
the antenna element includes
a step portion provided on the bottom of the recess, the step portion having the hole provided therein, and
a first peripheral portion coupled to the step portion and provided on the surface of the base, and
the projection has a height not larger than a height of the first peripheral portion of the antenna element.

2. The antenna device according to claim 1, wherein
the base has a first edge connected to the surface and a second edge connected to the surface, the second surface being opposite to the first edge beyond the surface, and
the recess of the base extends along the surface from the first edge to the second edge.

3. The antenna device according to claim 2, wherein
the antenna element further includes a second peripheral portion provided on the surface of the base, the second peripheral portion being coupled to the step portion, and
the step portion is located between the first peripheral portion and the second peripheral portion.

4. The antenna device according to claim 1, wherein
the base has a first edge connected to the surface and a second edge connected to the surface, the second edge of the base being opposite to the first edge beyond the surface,
the recess of the base extends along the surface from the second edge to a position between the first edge and the second edge,
the antenna element further includes
a second peripheral portion provided on the surface of the base, and
a bridge portion provided on the bottom of the recess, the bridge portion being connected to the first peripheral portion and the second peripheral portion and being located between the first peripheral portion and the second peripheral portion, and
the step portion is located between the first peripheral portion and the second peripheral portion and extends from the bridge portion.

5. An antenna device comprising:
a base having an insulating property and having a surface thereof, the surface of the base having a recess provided therein, the recess of the base having a bottom;
a projection projecting from the bottom of the recess; and
an antenna element made of a metal plate, the antenna element having a hole provided therein, the projection being inserted in the hole of the antenna element, the antenna element being fixed onto the surface of the base with the projection by swage locking, wherein
the antenna element includes
a step portion provided on the bottom of the recess, the step portion having the hole provided therein, and
a peripheral portion coupled to the step portion and provided on the surface of the base,
the hole of the antenna element is provided in the step portion,
the projection includes
a trunk projecting from the bottom of the recess and being inserted in the hole, and
a head provided at a tip of the trunk and having a diameter larger than a diameter of the hole, and
the projection has a height not larger than a height of the first peripheral portion of the antenna element.

6. The antenna device according to claim 5, wherein the base and the projections are provided unitarily, and the head of the projection is formed by being crushed.

7. The antenna device according to claim 5, wherein
the base has a first edge connected to the surface and a second edge connected to the surface, the second edge being opposite to the first edge beyond the surface, and
the recess of the base extends along the surface from the first edge to the second edge.

8. The antenna device according to claim 7, wherein
the antenna element further includes a second peripheral portion provided on the surface of the base, the second peripheral portion being coupled to the step portion, and
the step portion is located between the first peripheral portion and the second peripheral portion.

9. The antenna device according to claim 5, wherein
the base has a first edge connected to the surface and a second edge connected to the surface, the second edge being opposite to the first edge beyond the surface,
the recess of the base extends along the surface from the first edge to a position between the first edge and the second edge,
the antenna element further includes
a second peripheral portion provided on the surface of the base, and
a bridge portion provided on the bottom of the recess, the bridge portion being connected to the first peripheral portion and the second peripheral portion and being located between the first peripheral portion and the second peripheral portion, and
the step portion is located between the first peripheral portion and the second peripheral portion and extends from the bridge portion.

10. The antenna device according to claim 9, wherein the first peripheral portion, the second peripheral portion, and the bridge portion are flush with each other.

11. A method of manufacturing an antenna device, comprising:
providing a base having an insulating property and having a surface thereof, the surface of the base having a recess provided therein, the recess of the base having a bottom, the base including a projection projecting from the bottom of the recess;
providing an antenna element made of a metal plate, the antenna element including
a step portion having a hole provided therein, and
a peripheral portion coupled to the step portion;
situating the antenna element on the base, such that the projection is inserted in the hole, the step portion is provided on the bottom of the recess, and the peripheral portion is provided on the surface of the base; and
fixing the antenna element onto the base by swage locking by crushing a tip of the projection such that the projection is prevented from projecting from the peripheral portion of the antenna element.
